(19) United States
(12) Patent Application Publication
(10) Pub. No.: US 2026/0196631 A1
(43) Pub. Date: Jul. 9, 2026

(54) BATTERY CONTAINER

(71) Applicant: JUSTRITE MANUFACTURING COMPANY, LLC DBA JUSTRITE SAFETY GROUP, Deerfleld, IL (US)

(72) Inventors: Shane Williford, Wilkesboro, NC (US); Mark Essig, High Point, NC (US)

(73) Assignee: JUSTRITE MANUFACTURING COMPANY, LLC DBA JUSTRITE SAFETY GROUP, Deerfield, IL (US)

(21) Appl. No.: 19/010,822

(22) Filed: Jan. 6, 2025

(51) Int. Cl. H01M 50/233; H01M 10/613; H01M 10/6563; H01M 10/658; H01M 50/224; H01M 50/227; H01M 50/231; H01M 50/256; H01M 50/262; H01M 50/383

(52) U.S. Cl. CPC H01M 50/233; H01M 10/613; H01M 10/6563; H01M 10/658; H01M 50/224; H01M 50/227; H01M 50/231; H01M 50/256; H01M 50/383; H01M 50/262

(57) ABSTRACT

A battery storage container can include an outer shell and a container disposed within the outer shell. The container can include container walls defining an interior volume configured for battery storage and quarantining of thermal runaway events inside the interior volume. The battery storage container can further include a fire-resistant coating disposed on an interior surface of the container walls, and a filtered vent defined by the outer shell and at least one wall of the container walls.

### FIELD

The present disclosure relates generally to containers for transporting a battery or for long term or short term battery storage. The disclosure particularly relates to containers in which rechargeable (e.g., lithium-ion) batteries can be transported or stored.

### BACKGROUND

Many industries involve the use of devices and machinery that are battery operated. Such batteries may include rechargeable batteries (e.g., lithium-ion batteries). Unfortunately, the proliferation of battery powered devices (including automobiles, hand tools, drones, and personal mobility devices) has caused a rise in battery related fires—resulting in property damage and personal injury. However, there is no safety standard or code for handling the transport of these batteries. Accordingly, there is a significant need for a container that can be used to safely transport rechargeable batteries, particularly in a setting where multiple battery packs—numbering from several battery packs to several dozen battery packs—need to be transported and/or stored for a period of time.

Rechargeable batteries can undergo thermal failure (or thermal runaway). These thermal failures can lead to a build-up of gases inside the outer ABS plastic shell of a battery pack. The build-up of gases can culminate in unsafe battery termination (e.g., a fiery explosion of flames, shards of battery casing, hot gas, battery acid, and toxic fumes/smoke). In certain situations, a thermal failure and subsequent battery termination has the potential to cause a daisy-chain effect—where neighboring battery packs can similarly begin thermal failure and termination in response to rapid increases in nearby temperature.

The subject matter claimed herein is not limited to embodiments that solve any disadvantages or that operate only in environments such as those described above. Rather, this background is only provided to illustrate one example technology area where some embodiments described herein may be practiced.

### SUMMARY

An aspect of the present disclosure relates to containers for transporting a battery. In some embodiments, a battery storage container may include an outer shell, a container disposed within the outer shell, the container includes container walls defining an interior volume configured for battery storage and quarantining of thermal runaway events inside the interior volume, a fire-resistant coating disposed on an interior surface of the container walls, and a filtered vent defined by the outer shell and at least one wall of the container walls. The battery storage container may also include embodiments where the outer shell includes steel or aluminum. The battery storage container may also include embodiments where the container walls comprise a segment of plywood, a segment of hardwood, an aluminum panel, or a steel panel. The battery storage container may also include embodiments where the interior surface of the container walls is fire-rated for at least a threshold duration of time. The battery storage container may also include embodiments where the filtered vent includes a double-paned barrier defining one or more through-holes.

The battery storage container may also include embodiments where a temperature of an outer surface of the outer shell is configured to remain below a threshold temperature during a thermal runaway event. The battery storage container may also include embodiments where the container walls comprise at least one of a segment of plywood that is between about 0.5 inches and about 3.0 inches thick, a segment of hardwood that is between about 0.5 inches and about 3.0 inches thick, or an aluminum panel that is between about 0.01 inches and about 0.13 inches thick. The battery storage container may also include embodiments where the container walls are configured to absorb a percussive blast originating from within the interior volume of the container, and maintain a structural integrity of the outer container wall during the percussive blast. The battery storage container may also include embodiments where the container walls are compliant with a Type 3 Magazine storage standard. Other technical features may be readily apparent to one skilled in the art from the following figures, descriptions, and claims. Other technical features may be readily apparent to one skilled in the art, having the benefit of this disclosure, include the following figures, descriptions, and claims.

Some embodiments comprise a carriable battery safe for transporting batteries, the carriable battery safe including an outer shell having a lid, a fire-rated container disposed within the outer shell, the fire-rated container including container walls defining an interior volume configured for battery storage and quarantining of thermal runaway events inside the interior volume, a gas filter controlling passage through the outer shell, and a hold to carry the carriable battery safe, the hold being attached to or defined by at least the outer shell. The carriable battery safe may also include embodiments where during a thermal runaway event, the container walls are configured to reduce a transfer of thermal energy to an environment external to the container walls. The carriable battery safe may also include embodiments where the container walls are configured to retain a projectile from an exploding battery inside the interior volume. The carriable battery safe may also include embodiments where the shell and container walls contact one another. The carriable battery safe may also include embodiments comprising a gasket configured to form a first seal and a second seal against the lid. The carriable battery safe may also include embodiments where a top opening into the interior volume is defined by a raised portion of the shell extending upward relative to a perimeter planar portion of the shell, and wherein the carriable battery safe further includes a first gasket positioned over the raised portion to form a first sealing engagement with the lid, and a second gasket positioned over the perimeter planar portion to form a second sealing engagement with the lid. The carriable battery safe may also include embodiments where the interior volume is configured to quarantine multiple lithium batteries during a thermal runaway event (e.g., multiple lithium batteries that are 21-volt, 56-volt, 80-volt, etc.). The carriable battery safe may also include embodiments where during a thermal runaway event, the gas filter (e.g., mineral wool) is configured to release pressure from inside the interior volume and reduce noxious gas emissions (e.g., hydrogen fluoride, hydrogen chloride, hydrogen cyanide, carbon monoxide, sulphur dioxide, methane, etc.). Other technical features may be apparent to one skilled in the art, having the benefit of this disclosure, including from the following figures, descriptions, and claims.

In certain embodiments, a battery transport box includes an outer shell including a top exterior wall, a bottom exterior wall, and side exterior walls. The battery transport box may also include an outer shell including a raised opening within the top exterior wall, the raised opening defined by a vertical portion extending upward from a horizontal protrusion. Embodiments of the battery transport box may also include an outer shell including a first plurality of apertures disposed within at least one of the side exterior walls, the first plurality of apertures defining an outer portion of a filtered vent. The battery transport box may also include an outer shell that can include a container disposed within the outer shell, the container including container walls. The container walls can include a top interior wall, a bottom interior wall, and a side interior wall defining a void corresponding to the at least one side exterior wall. The battery transport box can additionally include a plate positioned over the void and a second plurality of apertures disposed within the plate. In some examples, the second plurality of apertures can define an inner portion of the filtered vent. In at least one example, the container walls define an interior volume configured for battery storage and quarantining of thermal runaway events inside the interior volume. The battery transport box can include a first gasket (e.g., a high-temperature gasket) disposed against the horizontal protrusion, and a second gasket (e.g., a high-temperature gasket) disposed against an inner surface and an outer surface of the vertical portion extending around the raised opening. The battery transport box may also include an outer shell including a fire-resistant coating disposed on an interior surface of the container walls. The battery transport box may also include an outer shell includes a filter media disposed between the first plurality of apertures and the second plurality of apertures. The battery storage container may also include embodiments where the filtered vent includes mineral wool (e.g., of various thicknesses) positioned inside the double-paned barrier. The carriable battery safe may also include embodiments where, upon explosion, any projectile ejected therefrom has at least 500 Joules of kinetic energy. Other technical features may be readily apparent to one skilled in the art, having the benefit of this disclosure, include the following figures, descriptions, and claims.

The subject matter claimed herein is not limited to the examples of embodiments recited above. Rather, this summary is only provided to provide an overview of various potential embodiments of this disclosure.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates an example schematic environment of a battery container, in accordance with one or more examples of the present disclosure.

FIG. 2 illustrates a top-front, perspective view of the battery container of FIG. 1, in accordance with one or more examples of the present disclosure.

FIG. 3 illustrates a top-back, perspective view of the battery container of FIG. 1, in accordance with one or more examples of the present disclosure.

FIG. 4 illustrates an exploded view of the battery container of FIG. 1, in accordance with one or more examples of the present disclosure.

FIG. 5 illustrates a perspective view of an interior of the battery container of FIG. 1, in accordance with one or more examples of the present disclosure.

FIG. 6 illustrates a lateral, cutaway view of a top portion of the battery container of FIG. 1, in accordance with one or more examples of the present disclosure.

FIG. 7 illustrates a perspective view of an interior back insert of the battery container of FIG. 5, in accordance with one or more examples of the present disclosure.

FIG. 8 illustrates a perspective, cutaway view of a vent of the battery container of FIG. 1, in accordance with one or more examples of the present disclosure.

FIG. 9 illustrates a top-down, cutaway view of the battery container of FIG. 1, in accordance with one or more examples of the present disclosure.

FIG. 10 illustrates a lateral, cutaway view of the battery container of FIG. 1, in accordance with one or more examples of the present disclosure.

FIG. 11 illustrates a front, cutaway view of the battery container of FIG. 1, in accordance with one or more examples of the present disclosure.

### DETAILED DESCRIPTION

Conventional containers are ill-suited and poorly designed to handle safe battery transportation. Specifically, many EN containers (e.g., under European safety standard EN 14470-1) are not designed for containment of thermal failure and battery termination. Instead, these types of containers are designed to protect the internal contents, such as flammable liquids, from external fire hazards. Thus, EN containers have fire-rated walls insulated with gypsum board—which lends to heavy, non-portable designs. Under these design considerations, EN containers do little to safely and adequately contain one or more batteries undergoing thermal failure and termination inside the EN container. In addition, the lengthy fire ratings also lend to complex designs, which in turn requires labor intensive manufacturing, longer lead times, and higher costs.

As mentioned above, battery terminations can occur inside a container during transportation. These battery terminations can be swift and severe (e.g., often beginning in as fast as a few seconds). As a result, lengthy fire ratings and traditional designs of EN containers protecting the inside of the container from the ambient environment are poorly designed for safe transport of rechargeable batteries. Similarly, fire suppression methods of some EN containers do little to contain thermal failure and battery termination inside the container, in part because lithium-ion batteries can sustain a burn with little or no external oxygen. Further, fire suppression methods of some EN containers do little to manage gases and pressure inside the container, which can exacerbate issues and/or allow fire to spread. Other containers, including conventional FM rated containers, are also not equipped to safely handle the transport of rechargeable batteries. For example, such containers do not have internal ventilation for depressurizing inside the container and are not equipped for containing percussive blasts.

Conversely, a battery container as disclosed herein can provide certain advantages over existing containers. For instance, in some embodiments, the container includes an exterior shell and interior walls or inserts that limit heat transfer and provide reinforcement against an explosive or ballistic events. Additionally, and in contrast to traditional containers that use heavy insulation materials, a battery container is disclosed that includes lighter materials, facilitating mobility, transport, and mounting of the battery container. Many other applications of such a battery container can also be implemented. For example, a battery container of the present disclosure can be used in manufacturing facilities to place good or spent batteries in storage when not in use or transport. In another example, a battery container of the present disclosure can serve as a safe drop-off location for spent batteries to be recycled.

In some embodiments, the container includes vents to control and manage internal gases and pressure, thus preventing the spread of fire while limiting explosive forces to the interior of the container. The battery container can further be configured to be versatile in mounting options and can accommodate different sizes and quantities of batteries. The battery container can further include various safety and monitoring systems, including sensors and communication networks, allowing for real-time monitoring and response. The container includes additional safety features such as fire-resistant coatings, reinforced latches, and intumescent seals to further contain thermal events within the container.

In one example, the battery container can include an insulated or reinforced shell or housing. In certain of these embodiments, the battery container can include a double-walled housing (e.g., an exterior shell and interior container walls) with at least one door or lid to enclose an interior volume. In these or other examples, the housing or shell of the battery container can help mitigate heat transfer from the interior volume to an ambient environment. Additionally, the dual-walled structure can act as reinforcement to help contain explosive events within the interior volume. Selectively reinforced portions can also help prevent deformation of the battery container during explosive events and help to safely route (and alleviate) internal pressure build-up through specially designed vents.

Instead of heavy insulation materials (e.g., gypsum board or plaster board), a battery container of the present disclosure is thus comparatively lighter weight than conventional EN containers. Accordingly, a battery container of the present disclosure can be more easily transported, moved, lifted, mounted, or stacked.

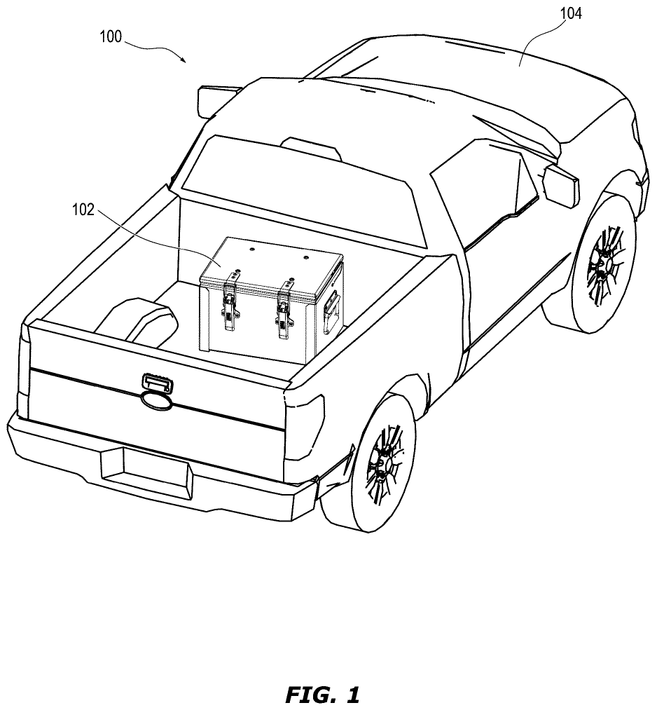

These and other embodiments are discussed below with reference to FIG. 1 through FIG. 11. However, those skilled in the art, having the benefit of this disclosure, will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates an example schematic environment of a battery container 102 in accordance with one or more examples of the present disclosure. In the illustrated embodiment, environment 100 depicts battery container 102 positioned on vehicle 104. Vehicle 104 can include a horizontal surface for storing, or positioning, battery container 102. For instance, in some embodiments, vehicle 104 can include a table, desk, platform, shelf, etc. It will also be appreciated that vehicle 104 need not contact the battery container 102 directly. For example, in some embodiments, vehicle 104 can transport a separate container containing battery container 102. In some embodiments, battery container 102 can be disposed or mounted on (or otherwise secured to) any feasible surface of vehicle 104. The battery container 102 can also be positioned on or within a vehicle bed, rack, storage compartment, etc. of the vehicle 104. The battery container 102 can, in certain implementations, be positioned inside the cab of the vehicle 104.

Accordingly, battery container 102 can be sized and shaped to accommodate a variety of different types of spatial footprints and transportation methods. In some examples, battery container 102 is sized and shaped to accommodate different volumes of battery containment, such as between a 1 and 50 gallon volume containment, between a 2 and 30 gallon volume containment, between a 3 and 20 gallon volume containment, or between a 5 and 15 gallon volume containment. In one or more examples, the battery container 102 is sized and shaped to hold multiple rechargeable (lithium) batteries (e.g., multiple 21-volt, 56-volt, 80-volt, or other suitable size batteries). Indeed, the battery container 102 can be sized and shaped to accommodate a range of battery sizes. In some examples, the battery container 102 is sized and shaped to hold between two 56-volt batteries and twenty 56-volt batteries, between five 56-volt batteries and fifteen 56-volt batteries, or between eight and twelve 56-volt batteries.

Likewise, battery container 102 can include a weight that allows users to easily maneuver the battery container 102 on or off the vehicle 104, up flights of stairs, etc. In some embodiments, battery container 102 can include various lightweight design features. In particular examples, battery container 102 ranges from about 2 pounds to 100 pounds, depending on the volume size of containment. In at least one example, battery container 102 is about 5 pounds to about 75 pounds, about 10 pounds to about 50 pounds, or about 12 pounds to about 25 pounds. Such a weight of battery container 102 can add portability to battery container 102, particularly in view of similar sized conventional EN style containers being orders of magnitude heavier.

In particular examples, (and as shown), battery container 102 is positioned in the bed of vehicle 104. A variety of mounting positions within vehicle 104 are herein contemplated. For example, battery container 102 can be mounted to a floor surface of the vehicle bed (e.g., adjacent to the rear cab window, adjacent to the wheels, adjacent to the tailgate, etc.). Additionally or alternatively, battery container 102 can be mounted to (or supported by) the walls of the vehicle bed. For instance, battery container 102 can be mounted on the bed rails extending between the rear cab window and the tail gate. In these or other examples, battery container 102 can be compatible with covered vehicle beds (e.g., with an enclosed shell disposed over the vehicle bed). Still, in other examples, battery container 102 can be mounted or positioned inside the cab (i.e., not in the vehicle bed). Vehicle 104 can correspond to a variety of different vehicles, including landscaping vehicles, military transport vehicles, emergency vehicles (e.g., ambulances, firetrucks, police vehicles), utility trucks, motorhomes, etc. Alternatively, to an actual vehicle, it will be appreciated that vehicle 104 can include trailers (e.g., utility trailers, welding trailers, etc.), campers (RV's), and the like.

In these or other examples, battery container 102 can be mounted with fasteners, interlocking members, fitted recesses or receptacles, etc. In other examples, battery container 102 can be placed on a surface (e.g., in a truck bed, similar to a toolbox). Thus, in some examples, battery container 102 may include weather-resistant features to operate (and prevent damage) despite exposure to the natural elements, such as rain, snow, or cold/hot temperatures. Examples of such features may include gaskets, sealants, coatings, covers, shells, shields, thermal blankets, thermal reflectors, etc. Alternatively, battery container 102 may be protected or at least partially encased by vehicle 104 (e.g., under the side panel of a firetruck).

In some embodiments, battery container 102 comprises a standalone or self-standing container. Although not schematically shown, in some embodiments, the battery container 102 may include rollers (e.g., caster wheels), support feet (e.g., mounting feet), legs (e.g., leveling legs), or other elements to support battery container 102 (e.g., on a vehicle surface).

Additionally, although these and other implementations described herein pictorially reference horizontal embodiments (e.g., with greater length than height), alternative embodiments of battery container 102 can be more vertical (e.g., with greater height than length). Such implementations may be particularly viable, for instance, in environments where battery container 102 rests in a constrained space (as opposed to a workbench surface or a vehicle surface).

Further, in one or more of the foregoing environments, more than one battery container 102 can be stacked atop each other or mounted to one another. In certain examples, one or more of battery container 102 in a stacked configuration can also be implemented with anchors (e.g., fasteners) to hold battery container 102 against a wall or support structure when in a stacked configuration.

Modifications to the foregoing environments also fall within the scope of the present disclosure. For example, in some embodiments, battery container 102 can communicate with one or more client devices via a network (e.g., to alert users, trigger a building alarm, activate emergency safety measures, flash a visual warning indicator, sound an audible siren, send an SMS message, etc.). Similarly, one or more sensors (e.g., temperature sensors, sound sensors, pressure sensors, smoke/gas sensors, light sensors, door ajar sensors, etc.) can be implemented within battery container 102 to communicate data to one or more client devices via the network. In such cases, one or more sensors can be implemented for real-time detection and/or in conjunction with a variety of Internet-of-Things arrangements and accessory device configurations.

In such an example, a client device can include a variety of computing devices. Some examples of computing devices include a smartphone, tablet, smart television, desktop computer, laptop computer, virtual reality device, augmented reality device, or other computing device. Other types of computing devices include a content server, data collection server, application server, communication server, third-party server, etc.

Regarding a network to facilitate such communication between battery container 102 and a client device, the network can also include a myriad of different types of networks (whether wired or wireless networks for communication). For instance, one or more connected components can communicate via a wireless local area network communication, wireless area network communication, wireless personal area network communication, wide area network communication, etc. Some particular examples of wireless communication include a Wi-Fi based communication, cellular-based network communication, satellite communication, mesh network communication, Bluetooth® communication, near-field communication, low-energy communication, Zigbee® communication, Z-wave communication, 6LoWPAN communication, radio frequency communication, etc. Other forms of network communication are based on wired connections, such as an Ethernet connection, USB connection, UART connection, USART connection, I2C connection, SPI connection, QSPI connection, etc.

Any of the features, components, and/or parts, including the arrangements and configurations thereof shown in FIG. 1 to FIG. 11 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 1 to FIG. 11.

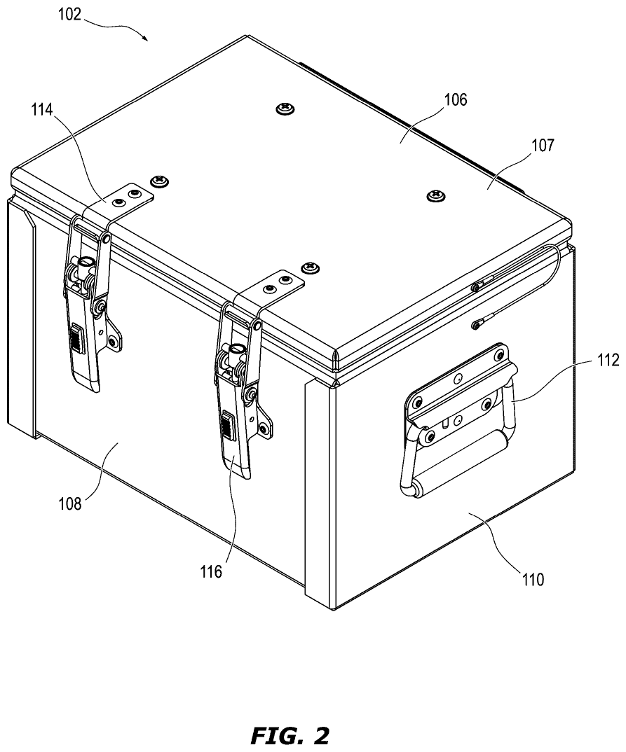

FIG. 2 illustrates a top-front, perspective view of an example battery container 102 of FIG. 1, in accordance with one or more examples of the present disclosure. In particular, FIG. 2 illustrates the battery container 102 comprising an exterior shell 107 including exterior walls (e.g., front exterior wall 108, right exterior wall 110, and lid 106 as visible in FIG. 2). The exterior walls can be reinforced in various ways (e.g., for increased rigidity, strength, thermal insulation, etc.). In particular, the exterior walls (at times, reinforced with interior inserts) can withstand and contain thermal failures (i.e., thermal runaway events) of one or more batteries, including explosive or percussive blasts and fire-blaze temperatures. For example, in some embodiments, a temperature of an outer surface of the outer shell (e.g., which may be in contact with the environment or environmental objects) can be configured to remain below a threshold temperature during a thermal runaway event. For example, in some embodiments, the outer surface of the outer shell can be configured to remain under 200 degrees Fahrenheit, under 150 degrees Fahrenheit, or 100 degrees Fahrenheit during an internal thermal runaway event. For instance, in a thermal runaway event when the internal volume exceeds 900 degrees Fahrenheit, for example, the outer surface of the outer shell can remain at approximately 75 degrees Fahrenheit. The outer surface of the outer shell can thus remain at a safe temperature (e.g., safe to touch, safe to transport, etc.)—despite a thermal runaway event inside the container 102—because heat transfer from the interior volume to the outer shell is substantially reduced or eliminated.

The exterior walls can include various materials and/or materials with various properties, including a metal material, a rigid material, a fire-resistant material, etc. In some embodiments, the exterior walls of shell 107 can include a thickness (or gauge) between 1 hundredth of an inch (0.01″) to ⅛ inch (e.g., for one or more metal layers). In some cases, the material can be steel or aluminum. In at least one example, the exterior walls include one or more aluminum layers of about 0.100 inch thickness. In certain specific implementations (discussed below), the exterior walls comprise multiple wall layers (e.g., an inner container wall and an outer container wall) in intimate contact with each other (or alternatively, separated by an insulating air gap).

Battery container 102 can further include one or more doors, or mechanisms for opening (e.g., such as lid 106). As shown, battery container 102 can include lid 106 which can be sealed via right clasp 116 and left clasp 114. Lid 106 (as depicted in FIG. 2) can hinge open to expose the interior volume of battery container 102. However, in other examples, lid 106 can open vertically, roll up, slide, etc. In particular implementations, lid 106 can auto-close or self-close (e.g., in the absence of an external force holding the lid 106 ajar). In particular examples, however, lid 106 can be manually opened and/or closed. Additionally, in some examples, lid 106 can lock. Further, in certain examples, lid 106 can include a same or similar construction as the exterior walls (e.g., front exterior wall 108 and right exterior wall 110). In at least one example, lid 106 can seat over and around a raised periphery edge defining an opening into the container 102. In this way, the lid can help mitigate or prevent flames from escaping through the container opening. Specific sealing engagements between the lid and the body of the container 102 are discussed further below in relation to subsequent figures.

In certain examples, lid 106 can also include reinforced portions. In particular examples, reinforced portions of lid 106 can help direct percussion blasts that may occur inside battery container 102 to proceed through vents or apertures (rather than allowing explosion relief at unintended areas of the lid 106). To illustrate, lid 106 can include reinforced latches or clasps. In these or other examples, reinforced latch plates can help ensure that the lid 106 remain shut, particularly during a percussion event (e.g., a battery explosion). The lid 106, or other portions of the container 102 can include reinforced portions resistant to deformation, blast forces, etc. Reinforced portions can include increased material thickness, treated areas (e.g., heat treated or hardened portions), add-on sections, or multiple sheets or layers of material (e.g., stacked metal sheets), etc.

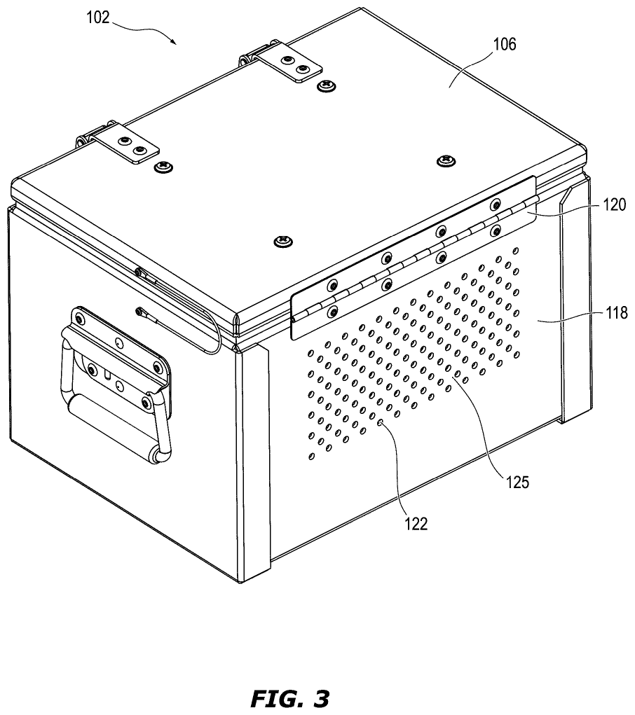

FIG. 3 illustrates a top-back, perspective view of an example battery container 102 of FIG. 1, in accordance with one or more examples of the present disclosure. In the illustrated embodiment, battery container 102 can include a vent 122 through back exterior wall 118 and into the interior volume of the battery container 102. The top lid 106 can be hinged to the outer shell, or exterior walls, via hinge 120.

Vent 122 can include an air inlet and/or an air outlet. For example, as seen in FIG. 2, vent 122 can include apertures exterior apertures 125 disposed on, or through, back exterior wall 118. Accordingly, in some cases, air or gasses can move unimpeded through exterior apertures 125.

In some embodiments, vent 122 can be unidirectional (e.g., exclusively an inlet or exclusively an outlet). Alternatively, vent 122 can be bi-directional (e.g., as both an inlet and outlet). In these or other examples, the vent 122 can include a gas filter. The gas filter can filter out noxious gases (e.g., heavy metal fumes, toxic fumes, strong odors, etc.). In some examples, the gas filter comprises a hydrogen fluoride filter that can reduce or eliminate emission of dangerous smoke and gas from the container 102.

In some examples, vent 122 can include active elements or powered elements, such as a fan, blower, pump, etc. (not shown with respect to FIG. 3) to create a vacuum (or near-vacuum conditions) inside the container 102 to help stifle fire spread. Thus, although not expressly shown in the figures, it will be appreciated that vent 122 can be modified in various ways. For example, vent 122 can include a raised collar. The raised collar can facilitate ducting, fittings, etc. for actively extracting (e.g., vacuum suctioning) out air from the interior volume of the battery container 102.

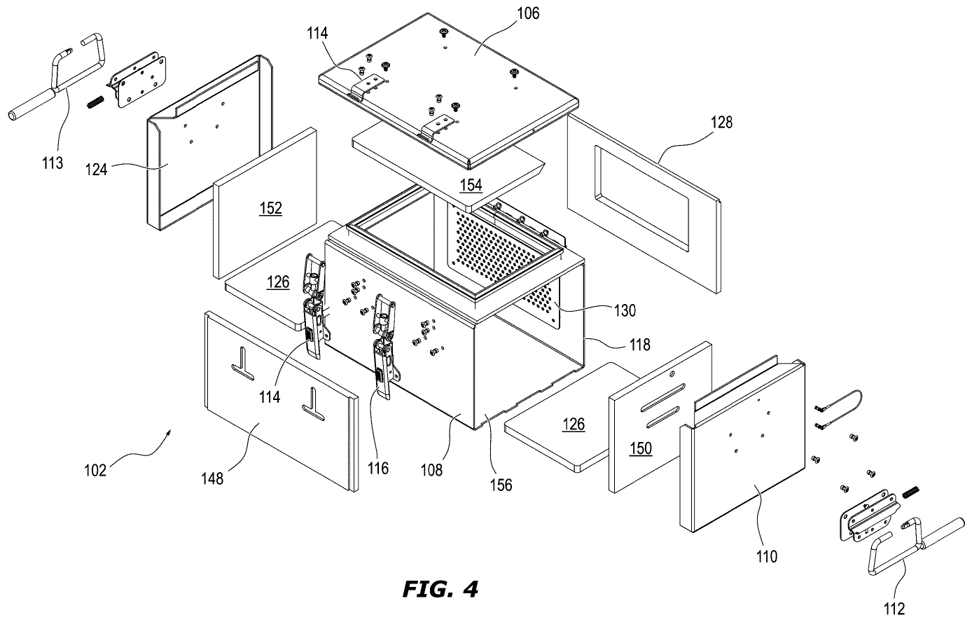

FIG. 4 illustrates an exploded view of the battery container 102 of FIG. 1, in accordance with one or more examples of the present disclosure. As seen FIG. 4, in the illustrated embodiment the battery container 102 includes an exterior shell (e.g., exterior walls), an interior container (e.g., interior inserts), and a filtered vent. In the illustrated embodiment, when assembled, left exterior wall 124 can be exterior to left insert 152, front insert 148 can be interior to front exterior wall 108, back insert 128 can be interior to back exterior wall 118, and right insert 150 can be interior to right exterior wall 110.

Bottom insert 126 and top insert 154 can be interior to bottom exterior wall 156 and lid 106, respectively. A vent panel 130 can be disposed against, or integral to, back exterior wall 118.

As will be appreciated by one of ordinary skill in the art, having the benefit of this disclosure, one or more of a variety of fasteners (e.g., screws, bolts, etc.) can be included to assemble battery container 102. Various ergonomic items, including left clasp 114, right clasp 116, left handle 113, and right handle 112, etc., can further be seen within FIG. 4. Handles are one example of a hold or hand hold. Other configurations of a hold are also herein contemplated. For example, a hold can include a cutout, indentation, protrusion, or grip integrally formed (or removably attached to) one or more walls of the container 102.

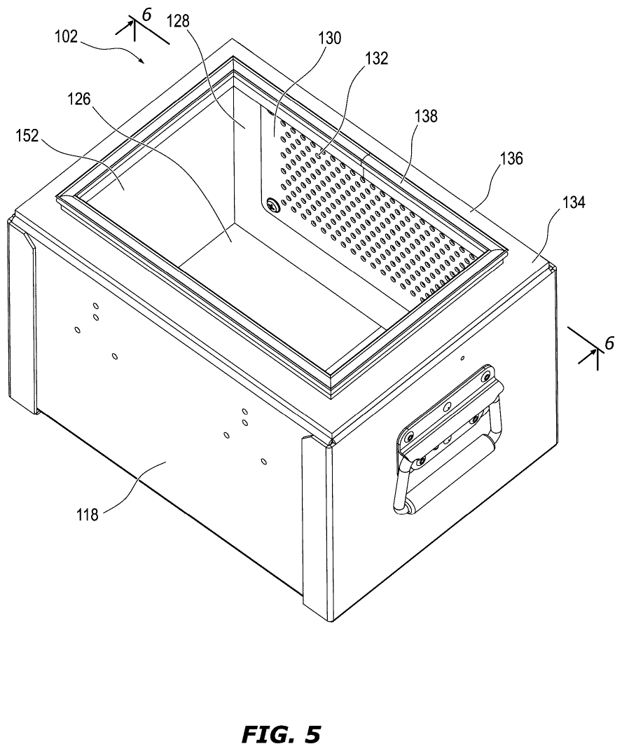

FIG. 5 illustrates a perspective view of the interior of battery container 102 of FIG. 1, in accordance with one or more examples of the present disclosure. In the illustrated embodiment, multiple inserts (e.g., back insert 128 and left insert 152) can be inserted against the exterior shell of battery container 102.

In some embodiments, interior inserts (e.g., back insert 128 and left insert 152) can be made of a fire-resistant, explosion-resistant, shock-resistant material, or otherwise be configured to contain the effects of one or more thermal runaway events. Interior inserts can be configured to prevent the propagation of damage to exterior shell or exterior walls of the battery container 102. Interior inserts may form any of the interior surfaces of battery container 102. Alternatively, in some embodiments, battery container 102 can forgo some, or any, interior inserts.

In some embodiments, interior inserts, such as back insert 128 and left insert 152, can be constructed using plywood, hardwood, aluminum, steel, ceramic, foam, and so on. For example, in some embodiments, interior inserts can be formed from wood (e.g., plywood or hardwood, or a segment of) that is anywhere from 0.5 inches thick to 3.0 inches thick.

Interior inserts (e.g., back insert 128 and left insert 152) can include a fire-resistant coating. For instance, in some cases, the interior inserts or interior walls of the battery container 102 can be configured to absorb the energy (e.g., thermal, kinetic, or percussive energy) from a percussive blast, explosion, or fire originating from within the interior volume of the container. In some cases, the interior inserts can be sacrificial, such that the interior inserts absorb energy of a thermal runaway or failure, while maintain a structural integrity of the outer container wall or shell. At the termination of a failure, or runaway event, interior inserts can then be replaced.

In some cases, the energy-absorption characteristics can be such that an exterior surface of the outer shell remains within a safe threshold-range (e.g., the exterior surface may be safe to touch). Accordingly, in some embodiments, an interior surface of the container walls can be fire-rated for at least a threshold duration of time. For instance, in some embodiments, the container walls can be fire-rated for about 45 minutes, or about 1 hour, or about 2 hours.

In some cases, the interior inserts can be configured to provide or meet a Type 1 Magazine, a Type 2 Magazine, a Type 3 Magazine, a Type 4 Magazine, or a Type 5 Magazine storage standard, as provided by the Bureau of Alcohol, Tobacco, Firearms, and Explosives (ATF). In particular examples, the interior inserts satisfy a Type 3 Magazine storage standard for “day boxes,” which according to the Type 3 Magazine standard, are fire-resistant, weather-resistant, and theft-resistant. Type 3 Magazine compliant day boxes are constructed of at least number 12-gauge steel and lined with at least ½-inch plywood or ½-inch Masonite-type hardboard. In some cases, the interior inserts can be configured to absorb anywhere between 500 Joules to 2.0 Megajoules of kinetic, thermal, or percussive energy (or any combination thereof) that may occur during a thermal runaway event. In some examples, the interior inserts can withstand projectiles (e.g., according to one or more ballistic ratings).

In some embodiments, a vent panel 130 (e.g., a plate, cover, screen, etc.) can be attached to back insert 128, and form a portion of a vent (e.g., vent 122 of FIG. 3). Vent panel 130 can include interior apertures 132 to form a continuous vent that allows airflow in a controlled (e.g., passively controlled or throttled) manner to proceed from within battery container 102 to the exterior of battery container 102. For instance, interior apertures 132 can include at least one aperture defined by the vent panel 130, and fluidly connected to the exterior apertures 125 (as discussed with respect to FIG. 3). Thus, the interior volume of battery container 102 and the outside ambient environment can be fluidly connected.

In some embodiments, vent 122 can include a flame arrestor (e.g., a wire mesh screen) and/or one or more filter media that limits, filters, and/or or controls fluid (e.g., air) exchange through vent 122 and/or interior apertures 132. In some examples, the filter media can remove, bind to, capture, or otherwise filter certain chemicals or substances in a smoke or gaseous fluid. In this manner, vent 122 can enable decompression/depressurization of the interior volume of battery container 102 by allowing filtered or screened air to be pushed (e.g., outward into the ambient environment) through interior apertures 132, thereby controlling or limiting the build-up of pressure inside the interior volume of battery container 102. In some examples, by reducing or eliminating trapped gasses inside battery container 102 (as may occur during a thermal runaway event), re-ignition of one or more battery elements inside battery container 102 can be mitigated or entirely prevented.

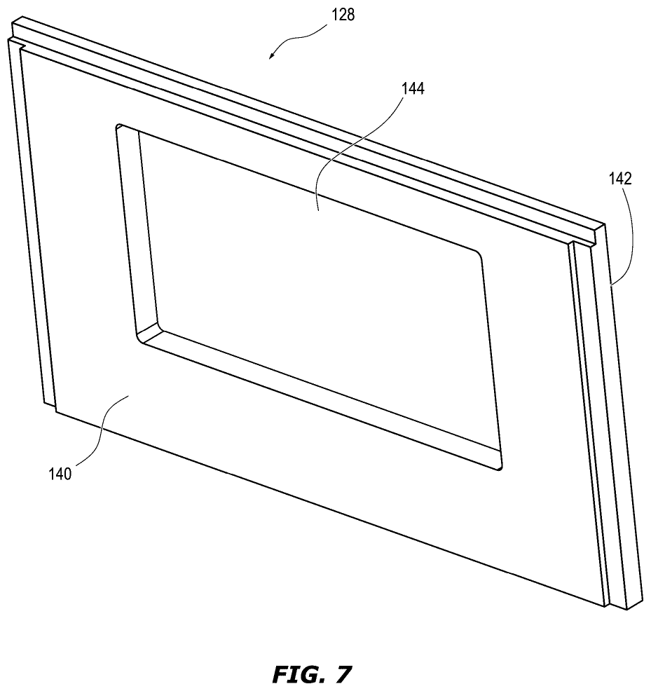

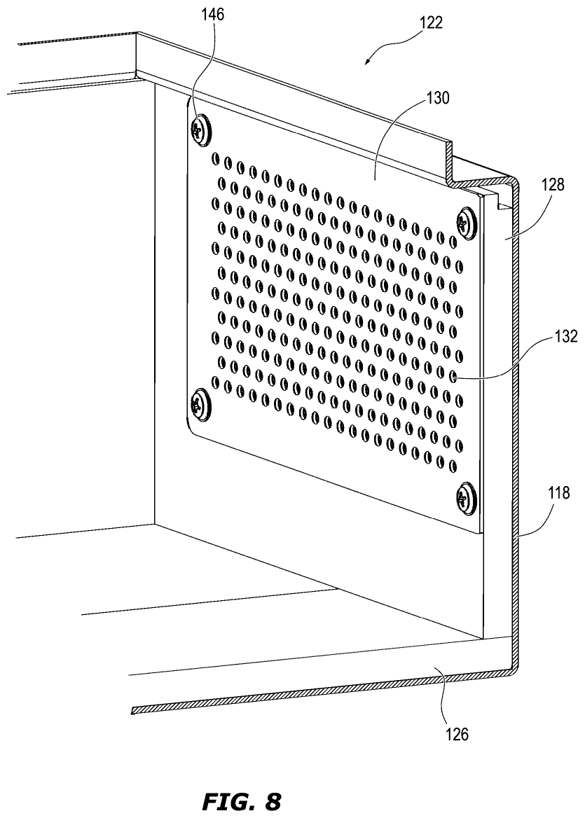

Additionally, vent 122 can serve as explosion relief in which a percussive blast (e.g., a burst of explosive energy) inside the interior volume of the battery container 102 is safely attenuated when routed through interior apertures 132 (as opposed to forcing unintended explosion release pathways around or through various structures of the lid 106). Additional detail of vent 122 is provided below in relation to FIGS. 7-8.

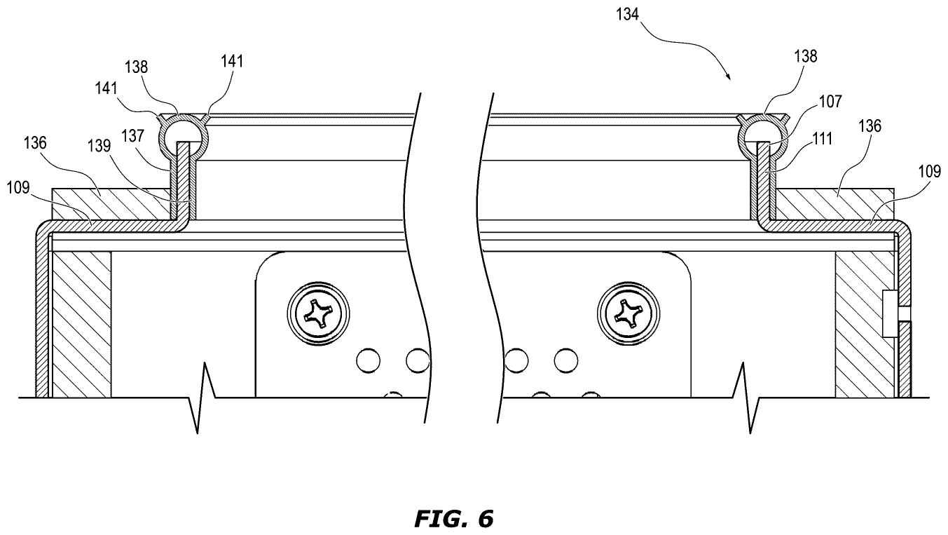

As is further seen with respect to FIG. 5, a gasket 134 surrounds the top portion of battery container 102. Gasket 134 includes a horizontal portion 136 and a vertical portion 138, and will be further described with respect to FIG. 6. In alternate embodiments, gasket 134 can be formed via two separate gaskets, and horizontal portion 136 and a vertical portion 138 can be separate and distinct gaskets for sealingly engaging with lid 106 of the battery container 102.

In these or other examples, the bounds of an interior volume of battery container 102 are bounded by the interior inserts and/or exterior walls, and the lid of battery container 102.

FIG. 6 illustrates a lateral, cutaway view of a top portion of battery container 102 of FIG. 1, in accordance with one or more examples of the present disclosure. In the illustrated embodiment, gasket 134 is disposed on and/or around an opening or top portion of shell 107.

As seen, shell 107 can include a top portion including a horizontal portion 109 and a vertical portion 111. Gasket 134 can similarly include a horizontal portion 136 disposed adjacent horizontal portion 109, and a vertical portion 138 which can be disposed adjacent, or around, vertical portion 111. Vertical portion 138 can include inner portion 139, outer portion 137, and engagement portion 141. Inner portion 139 and outer portion 137 of gasket 134 can surround vertical portion 111 of shell 107. In some embodiments, gasket 134 can be held in place via a frictional fit of inner portion 139, outer portion 137, and vertical portion 111 of shell 107.

As discussed, in some embodiments, gasket 134 can be formed via two separate gaskets, and horizontal portion 136 and vertical portion 138 can be separate and distinct gaskets for sealingly engaging with lid 106 of the battery container 102.

In such a configuration, horizontal portion 136 and vertical portion 138 can be distinct gasket systems that function independently and cooperatively to provide a secure sealing engagement between lid 106 and container shell 107. In some embodiments, the gasket defined by horizontal portion 136 can engage directly with the horizontal portion 109 of the shell and portions of the lid, providing a first engaging seal. This gasket can be disposed on the horizontal surface defined by horizontal portion 109 of container shell 107. A seal formed via the gasket (e.g., horizontal portion 136) and the lid can be continuous along an entire perimeter of the container shell 107.

Similarly, a gasket defined by vertical portion 138 would interact with the vertical portion 111 of the shell 107. This vertical gasket is configured to fit tightly against the walls of vertical portion 111 of shell 107, sealing vertical portion 111 which defines the opening of the container shell 107. The vertical gasket formed by vertical portion 138 can extend around an entire perimeter of the vertical portion 111 to ensure that no gaps or leaks exist such that heat, gases, debris, or flames could escape.

When sealed, the horizontal gasket formed by horizontal portion 136 can be compressed between the lid 106 and the horizontal portion 109 of the shell 107. In addition, the vertical gasket formed by vertical portion 138 can redundantly seal and facilitate prevention of leakage or movement around the sides of the lid.

In such a dual-gasket system, the horizontal and vertical gaskets can be aligned to ensure that each sealing function is complemented, or that the overall sealing is accomplished cooperatively. In some examples, at least one of the horizontal gasket or the vertical gasket is a high temperature gasket (e.g., designed to withstand high heat, burning gases, and/or flames). In particular examples, both of the horizontal gasket and the vertical gasket are high temperature gaskets. For instance, as seen in FIG. 6, outer portion 137 can extend down so as to be entrapped, or engaged, via a vertical portion of horizontal portion 136. Otherwise stated, gaskets defined by outer portion 137 and horizontal portion 136 can slightly overlap, providing an additional thickness, joining, and protection at the junction of the (potential) two gaskets. Such a seamless seal can increase robustness and diminish (or eliminate) points of weakness in the seal.

When the battery container 102 is in a closed configuration (e.g., the lid 106 is closed), the lid 106 of the container 102 can at least partially seal against engagement portion 141 of gasket 134. In some examples, the lid 106 of the battery container 102 can form a hermetic seal, smoke seal, fluid seal, etc. against engagement portion 141 of gasket 134.

In some cases, two different seals can be formed between a lid of the battery container and gasket 134. For example, in some embodiments, a first seal can be formed by the horizontal portion 136 of gasket 134 and the lid, and a second seal can be formed by the engagement portion 141 and the lid. Accordingly, redundancy with respect to sealing the battery container can provide enhanced sealing capabilities to quarantine the interior volume from the ambient environment. As used herein, the term “quarantine” can refer to isolation (whether thermal, chemical, kinetic, gaseous, or otherwise) of the interior volume from the ambient environment. A quarantining of the interior volume can prevent (or reduce) elements—such as smoke, heat, fire, etc.—from escaping the interior volume. Otherwise stated, a thermal runaway event and its effects can be quarantined to the interior volume.

Any of the features, components, and/or parts, including the arrangements and configurations thereof shown in FIG. 6 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 6.

FIG. 7 illustrates a perspective view of an interior back insert 128 of the battery container 102 of FIG. 5, in accordance with one or more examples of the present disclosure. In this view, a perspective view of back insert 128 is seen.

As seen in the illustrated embodiment, back insert 128 may include an interior surface 140, a ridge 142, and a void 144. In some embodiments, interior surface 140 can face and define an interior surface of the inner volume of the battery container, while ridge 142 can extend around a periphery of the back insert 128, and facilitate arrangement with other interior inserts of the battery container.

In some embodiments, back insert 128 can be disposed against the back exterior wall of the shell of the battery container. Accordingly, in some embodiments, void 144 can be disposed between the vent panel and interior apertures, and exterior apertures of the battery container. Such a configuration will be further seen and described with respect to FIG. 8.

In some embodiments, back insert 128 can forego void 144, and the void, and vent can be placed on a separate part or portion of the battery container. In some embodiments, any of the interior inserts can include a similar void or space (to facilitate one or more vents).

In particular, void 144 includes a rectangular-shaped space. However, it will be appreciated that void 144 can include a myriad of different configurations (e.g., circular shaped configurations, triangular shaped configurations, square shaped configurations, polygonal shaped configurations, etc.). In at least some examples, different-shaped configurations of void 144 can provide different air flow properties (as can hole size and spacing).

Any of the features, components, and/or parts, including the arrangements and configurations thereof shown in FIG. 7 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 7.

FIG. 8 illustrates a perspective, cutaway view of vent 122 of battery container 102 of FIG. 1, in accordance with one or more examples of the present disclosure. In the illustrated embodiment, the vent can include interior apertures 132, a void in back insert 128 (as was seen in FIG. 7), and exterior apertures (not shown in FIG. 8).

As seen in the arrangement illustrated in FIG. 8, back insert 128 can be disposed adjacent to back exterior wall 118. Vent panel 130 can be disposed against interior surface 140 of back insert 128. A fixing mechanism 146 (e.g., one or more screws) can be used to hold vent panel 130 in place.

In some embodiments, a void (not shown in FIG. 8) of back insert 128 can be disposed between interior apertures 132 and the exterior apertures. In some cases, the void can contain a filter media, such that the airflow, or fluid flow from within the interior of the battery container is filtered as it passes through vent 122. In some instances, such filter media can be mineral wool.

The filter media can serve to filter toxic gases and particles (e.g., gaseous Hydrogen Fluoride, Methane, Carbon Monoxide, etc.) released from a battery failure and/or runaway event.

As mentioned above, vent 122 can be an air inlet or an air outlet. In particular implementations (e.g., not shown with respect to FIG. 8), vent 122 can include a threaded inner surface to engage a pneumatic fitting that provides cool air (or ambient air) into the interior volume of the battery container. Alternatively, in some embodiments, a threaded inner surface of the vent 122 can engage a vacuum fitting for sucking out air from the interior volume of the battery container.

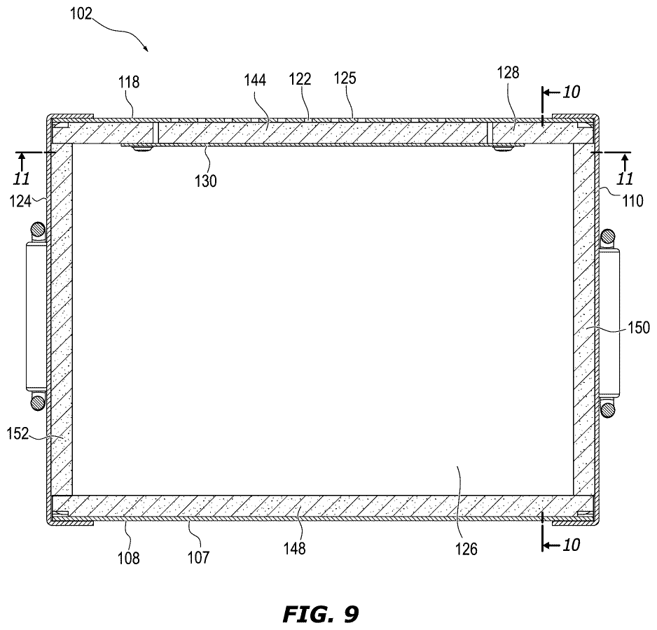

FIG. 9 to FIG. 11 respectively illustrate different cross-sections of battery container 102 of FIG. 1, in accordance with one or more examples of the present disclosure. The views of these figures are taken at cross-sections indicated in FIG. 5.

FIG. 9 illustrates a top-down, cutaway view of battery container 102 of FIG. 1, in accordance with one or more examples of the present disclosure. As shown, battery container 102 includes back exterior wall 118, right exterior wall 110, left exterior wall 124, and front exterior wall 108 of shell 107. Back insert 128, right insert 150, left insert 152, and front insert 148 can be disposed interior and/or adjacent to the exterior walls. In some embodiments, such a configuration can preserve and protect the outer shell 107 from damage, which may be limited to the interior inserts. In alternate embodiments, interior inserts may be forgone.

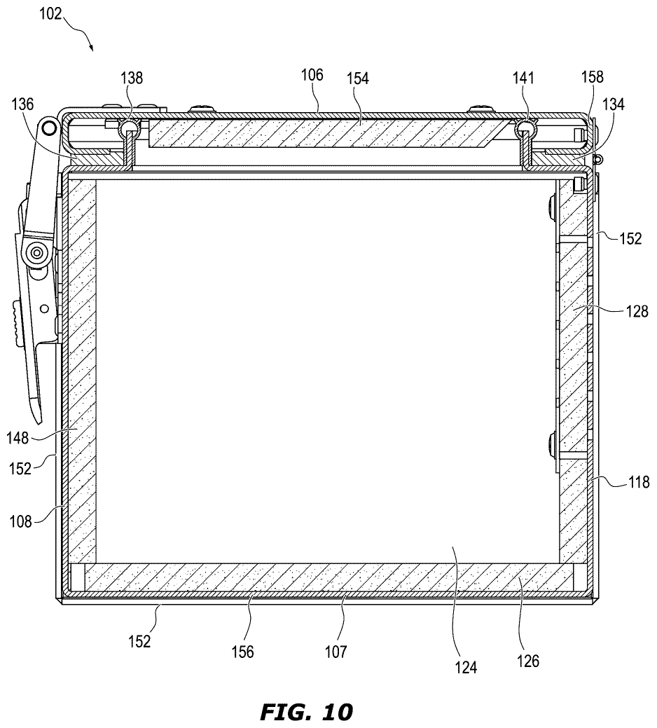

As will be described with respect to FIG. 10, in a same or similar manner, a lid of battery container 102 can include a similar construction. In these or other examples, any of the interior inserts can range from a ½ inch span to a 5 inch span between the outer container wall and the inner container wall. In particular implementations, any of the interior inserts can span between 1 inch and 2 inches in thickness.

As seen in the illustrated embodiment, void 144 of back insert 128 can be disposed between exterior apertures 125 and vent panel 130. In particular examples, void 144 can be entirely devoid of any insulation material (apart from the present air particles and container components disposed in the air gap). However, in some embodiments, the battery container 102 can include a lightweight insulation material (i.e., lighter than gypsum board). For example, void 144 can include mineral wool, spray foam, aerogel, polystyrene, polyurethane, fiberglass, cellulose insulation, polar fleece, etc. In at least some examples, a lightweight insulation material in the void 144 can mitigate heat transfer from the interior volume of battery container 102 to the exterior walls.

FIG. 10 illustrates a lateral, cutaway view of battery container 102 of FIG. 1, in accordance with one or more examples of the present disclosure. As shown, battery container 102 includes back exterior wall 118, front exterior wall 108, lid 106 and bottom exterior wall 156 of shell 107. Back insert 128, front insert 148, top insert 154, and bottom insert 126 can be disposed interior and/or adjacent to the exterior walls.

As seen, lid 106 can form a hermetic and/or intumescent seal and/or sealingly engage with both engagement portion 141 and horizontal portion 136 of gasket 134. For example, a curvature 158 of lid 106 can extend past engagement portion 141 and fold to sealingly engage with a horizontal portion 136 of gasket 134.

As mentioned, in some examples, battery container 102 can include intumescent seals between lid 106 and gasket 134. In some examples, intumescent seals include fire-resistant material(s). Additionally, the intumescent seals can expand in the presence of elevated temperatures (e.g., to entirely or partially seal smoke and flames inside the interior volume of battery container 102).

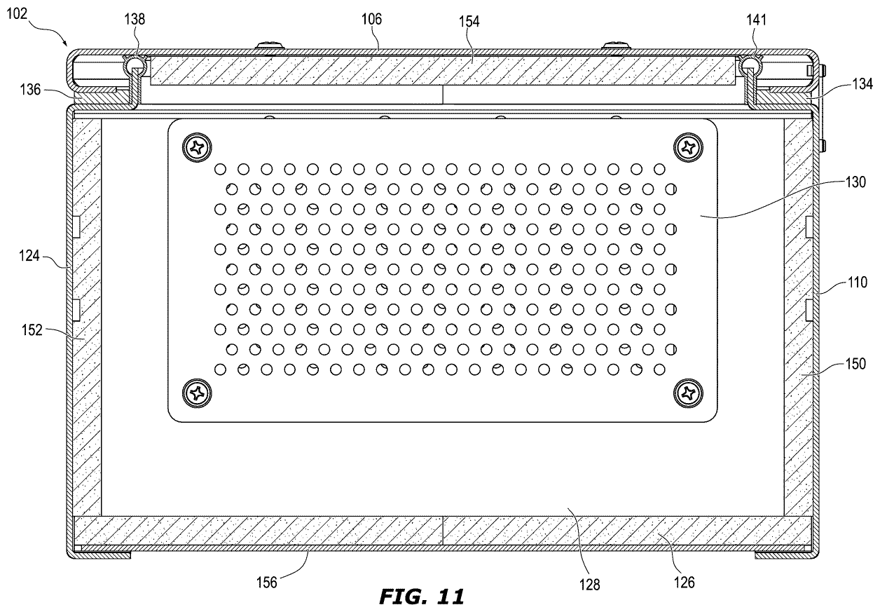

FIG. 11 illustrates a front, cutaway view of battery container 102 of FIG. 1, in accordance with one or more examples of the present disclosure. As shown, battery container 102 includes lid 106, left exterior wall 124, right exterior wall 110, and bottom exterior wall 156 of shell 107. Top insert 154, left insert 152, right insert 150, and bottom insert 126 can be disposed interior and/or adjacent to the exterior walls. Vent panel 130 can be disposed against back insert 128, as has been previously discussed.

Any of the features, components, and/or parts, including the arrangements and configurations thereof shown in FIG. 8 to FIG. 11 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 8 to FIG. 11.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed.

It will be apparent to one of ordinary skill in the art, having the benefit of this disclosure, that many modifications and variations are possible in view of the above teachings. Indeed, various inventions have been described herein with reference to certain specific aspects and examples. However, many variations are possible without departing from the scope and spirit of the inventions disclosed herein. Specifically, those inventions set forth in the claims below are intended to cover all variations and modifications of the inventions disclosed without departing from the spirit of the inventions. The terms “including” or “includes” as used in the specification shall have the same meaning as the term “comprising.” The terms “about,” “approximate,” or “substantially” should be interpreted as +/−10 % of a given value, unless stated otherwise.

What is claimed is:

1. A battery storage container, comprising:
an outer shell;
a container disposed within the outer shell, the container comprising container walls defining an interior volume configured for battery storage and quarantining of thermal runaway events inside the interior volume;
a fire-resistant coating disposed on an interior surface of the container walls; and
a filtered vent defined by the outer shell and at least one wall of the container walls.

2. The battery storage container of claim 1, wherein the outer shell comprises steel or aluminum.

3. The battery storage container of claim 1, wherein the container walls comprise a segment of plywood, a segment of hardwood, an aluminum panel, or a steel panel.

4. The battery storage container of claim 1, wherein the interior surface of the container walls is fire-rated for at least a threshold duration of time.

5. The battery storage container of claim 1, wherein the filtered vent comprises a double-paned barrier defining one or more through-holes.

6. The battery storage container of claim 5, wherein the filtered vent comprises mineral wool positioned inside the double-paned barrier.

7. The battery storage container of claim 1, wherein a temperature of an outer surface of the outer shell is configured to remain below a threshold temperature during a thermal runaway event.

8. The battery storage container of claim 1, wherein the container walls comprise at least one of:
a segment of plywood that is between about 0.5 inches to about 3.0 inches thick;
a segment of hardwood that is between about 0.5 inches to about 3.0 inches thick; or
an aluminum panel that is about between about 0.01 inches to about 0.13 inches thick.

9. The battery storage container of claim 1, wherein the container walls are configured to:
absorb a percussive blast originating from within the interior volume of the container; and
maintain a structural integrity of the outer container wall during the percussive blast.

10. The battery storage container of claim 1, wherein the container walls are compliant with a Type 3 Magazine storage standard.

11. A carriable battery safe for transporting batteries, the carriable battery safe comprising:
an outer shell having a lid;
a fire-rated container disposed within the outer shell, the fire-rated container comprising container walls defining an interior volume configured for battery storage and quarantining of thermal runaway events inside the interior volume;
a gas filter controlling passage through the outer shell; and
a hold to carry the carriable battery safe, the hold being attached to or defined by at least the outer shell.

12. The carriable battery safe of claim 11, wherein during a thermal runaway event, the container walls are configured to reduce a transfer of thermal energy to an environment external to the container walls.

13. The carriable battery safe of claim 11, wherein the container walls are configured to retain a projectile from an exploding battery inside the interior volume.

14. The carriable battery safe of claim 13, wherein, upon explosion, the projectile has at least 500 Joules of kinetic energy.

15. The carriable battery safe of claim 11, wherein the shell and container walls contact one another.

16. The carriable battery safe of claim 11, further comprising a gasket configured to form a first seal and a second seal against the lid.

17. The carriable battery safe of claim 11, wherein a top opening into the interior volume is defined by a raised portion of the shell extending upward relative to a perimeter planar portion of the shell, and the carriable battery safe further comprises:
a first gasket positioned over the raised portion to form a first sealing engagement with the lid; and
a second gasket positioned over the perimeter planar portion to form a second sealing engagement with the lid.

18. The carriable battery safe of claim 11, wherein the interior volume is configured to quarantine multiple 56-volt lithium batteries during a thermal runaway event.

19. The carriable battery safe of claim 11, wherein during a thermal runaway event, the gas filter is configured to release pressure from inside the interior volume and reduce noxious gas emissions.

20. A battery transport box, comprising:
an outer shell comprising:
a top exterior wall, a bottom exterior wall, and side exterior walls;
a raised opening within the top exterior wall, the raised opening defined by a vertical portion extending upward from a horizontal protrusion;
a first plurality of apertures disposed within at least one of the side exterior walls, the first plurality of apertures defining an outer portion of a filtered vent;
a container disposed within the outer shell, the container comprising:
container walls comprising a top interior wall, a bottom interior wall, and a side interior wall defining a void corresponding to the at least one side exterior wall;
a plate positioned over the void and comprising a second plurality of apertures disposed within the plate, the second plurality of apertures defining an inner portion of the filtered vent;
wherein the container walls define an interior volume configured for battery storage and quarantining of thermal runaway events inside the interior volume;
a first gasket disposed against the horizontal protrusion; and
a second gasket disposed against an inner surface and an outer surface of the vertical portion extending around the raised opening;
a fire-resistant coating disposed on an interior surface of the container walls; and
a filter media disposed between the first plurality of apertures and the second plurality of apertures.
